(19) United States
(12) Patent Application Publication
(10) Pub. No.: US 2010/0046505 A1
(43) Pub. Date: Feb. 25, 2010

(54) Internet Telephony Device and Method of Monitoring User Status

(76) Inventors: Jason Saw, Singapore (SG); Ann Tiong Ong, Singapore (SG); Subrata Basak, Singapore (SG)

Correspondence Address: CAHN & SAMUELS LLP, 1100 17th STREET NW, SUITE 401, WASHINGTON, DC, 20036, US

(21) Appl. No.: 12/522,125

(22) PCT Filed: Jan. 5, 2007
(86) PCT No.: PCT/SG07/00004

§ 371 Date: Sep. 25, 2009

(51) Int. Cl. H04L 12/66

(52) U.S. Cl. 370/352

(57) ABSTRACT

An Internet telephony device is provided, which comprises a voice processing unit capable of processing voice signals into electrical signals and vice versa, and a microprocessor comprising an embedded client application for communicating said electrical signals to an Internet telephony server over a network. The Internet telephony device further comprises at least one motion detector adapted to generate motion signals based on the detection of motion in the vicinity of the Internet telephony device. The motion detector is coupled to the microprocessor to determine user status of the Internet telephony device based on the motion signals.

This invention relates to a telephone device, in particular, an Internet telephony device capable of monitoring its user status. The invention also relates to a method of monitoring a user status of an Internet telephony device.

### BACKGROUND OF THE INVENTION

Internet telephony, also called Voice over Internet Protocol (VoIP) or IP telephony, has become popular with the widespread usage of IP (Internet Protocol) based networks. The inexpensive or even free VoIP phone calls worldwide as well as the mobility of VoIP have been attracting increasing number of users. Some of the popular VoIP services include Skype™, Microsoft Windows Live™ Messenger and Yahoo!® Messenger with Voice.

VoIP services support PC (personal computer) to PC, PC to telephone (including mobile phone), and telephone to PC phone calls. Before making an Internet telephone call using a PC, a VoIP application software is required to be installed on the PC. Every time a user wants to make a call, he needs to turn on the PC, connect to the Internet and launch the VoIP application software. This inconvenience for regular telephone call using the PC has been eliminated by a standalone telephone device embedded with the VoIP application software running on an embedded microprocessor. With the standalone telephone device, the user can make an Internet telephone call without the usage of the PC.

Although the standalone telephone device offers much convenience to the user, there are some features which are difficult to be ported from the PC to the standalone telephone device. One of the key features is the online status detection. Taking the Skype™ software as an example, the Skype™ software is able to determine whether the user is operating the PC by detecting the activity of mouse or keyboard. With the knowledge of the operating status of the PC, user status of the Skype™ software can be determined and automatically updated by the Skype™ software. If there is no operation of the PC within a default period of 20 minutes, user status is determined to be “Away”; if there is no operation of the PC within a default period of 60 minutes, user status is determined to be “Unavailable”. When the mouse or keyboard of the PC is touched, the Skype™ software automatically resets the user status to “Online”. Thus, other persons listed in the contact list of the Skype™ software would be updated of the current user status and would be able to estimate how long the user has been away.

Whereas for the standalone telephone device, it is difficult to detect the user status since there is no mouse or keyboard. The touching of the keypad of the standalone telephone device could indicate the presence of the user. However, different from the user of a PC who continuously touches the mouse or keyboard when operating the PC, the user of the standalone telephone device will not touch the keypad unless he is going to make a call. Therefore, the indication of the keypad activity is not accurate for the purpose of monitoring the user status.

Accordingly, it is an object of the present invention to provide an Internet telephony device capable of monitoring its user status. It is another object of the invention to provide a method of monitoring user status of an Internet telephony device.

### SUMMARY OF THE INVENTION

The object of the present invention is achieved by a device and a method of monitoring user status of an Internet telephony device as claimed in the respective independent claims, which utilize a motion detector for monitoring user activity in the vicinity of the Internet telephony device.

In a first aspect, there is provided an Internet telephony device, which comprises a voice processing unit capable of processing voice signals into electrical signals and vice versa, and a microprocessor comprising an embedded client application for communicating said electrical signals to an Internet telephony server over a network. The Internet telephony device further comprises at least one motion detector adapted to generate motion signals based on the detection of motion in the vicinity of the Internet telephony device. The motion detector is coupled to the microprocessor to determine user status of the Internet telephony device based on the motion signals.

In another aspect of the invention, a method of monitoring user status of an Internet telephony device is provided. The method comprises detecting motion in the vicinity of the Internet telephony device by at least one motion detector, generating motion signals based on said detection of motion, and determining the user status of the Internet telephony device based on the motion signals generated within a time period.

These aspects of the invention will be more fully understood in view of the following description, drawings and non-limiting examples.

### BRIEF DESCRIPTION OF THE DRAWINGS

FIG. 1 shows an Internet telephony device according to one embodiment of the invention.

FIG. 2 shows an Internet telephony device according to another embodiment of the invention.

FIG. 3 shows a hardware block diagram of the Internet telephony device of FIG. 2.

FIG. 4 shows a hardware block diagram of a PIR motion detector according to one embodiment of the invention.

FIG. 5 shows a flowchart of monitoring user status according to one embodiment of the invention.

FIG. 6 shows a flowchart of monitoring user status according to another embodiment of the invention.

FIG. 7 shows a flowchart of monitoring user status according to another embodiment of the invention.

### DETAILED DESCRIPTION

The present invention is based on the finding that the motion detected by a motion detector may be used to indicate the user activity in the vicinity of an Internet telephony device, thereby used to determine user status of the Internet telephony device.

According to an embodiment of the present invention, the Internet telephony device may comprise a voice processing unit which is capable of processing voice signals into electrical signals and vice versa, and a microprocessor comprising an embedded client application capable of communicating the electrical signals to an Internet telephony server over a network. The Internet telephony device may further comprise at least one motion detector adapted to generate motion signals based on the monitoring of motion in the vicinity of the Internet telephony device. The motion detector is coupled to the microprocessor to determine user status of the Internet telephony device based on the motion signals.

The client application embedded in the microprocessor may be any desired VoIP application. Some popular examples include, but are not limited to, Skype™, Microsoft Windows Live™ Messenger and Yahoo!® Messenger with Voice. As known, some of the user status available to these applications includes “Online”, “Available”, “Away”, “Unavailable”, “Offline”, “Busy” and “Invisible”, which will be presented to other people in the contact list of the VoIP application.

The motion detector used in the present invention may be any motion detector that can be integrated in any telephone. Examples of motion detectors include Passive Infrared Sensors (PIR). PIR sensors have been employed in security or alarm systems, such as in GB 2393306 to detect intruders in a secured area. Other examples of using PIR sensors in security phones are described in GB 2409128 and U.S. Pat. No. 7,031,436. In addition, U.S. Pat. No. 6,631,179 and U.S. Pat. No. 7,092,380 provide some other examples of using motion detectors to activate a communication device.

According to one embodiment of the present invention, the at least one motion detector may comprise a PIR sensor, an ultrasonic sensor and/or a microwave sensor. PIR sensors are capable of detecting motion of an infrared emitting source, such as a human body, and may be made from natural or artificial pyroelectric materials. Ultrasonic sensors are capable of emitting ultrasonic pulses and measuring the reflection thereof by a moving object. Finally, microwave sensors are capable of emitting microwaves and measuring the microwaves bounced off an object.

The motion detector may be positioned such that its field of view captures the area where the user activity is most likely to happen. In one embodiment, only one motion detector is positioned in the front panel of the Internet telephony device such that a user's activity in front of the Internet telephony device will be in the sensing area of the motion detector. In another embodiment, a plurality of motion detectors (at least two) are integrated into the telephony device in a circular matter such that a user's activity will be sensed in 360 degree.

The Internet telephony device may further comprise a motion detection application. In one embodiment, the motion detection application is embedded in the microprocessor. For example, the motion detection application may run on an ARM9 core based CX8201 microprocessor over uCLinux kernel. Alternatively, the motion detection application may be embedded in the motion detector. The motion detection application may be a programmed application written in any suitable programming languages.

The motion detection application is adapted to determine the user status of the Internet telephony device based on the motion signals generated by the motion detector. As explained above, the client application, e.g., the Skype™ application running on a PC will display and present its current user status to people in its contact list, including “Online”, “Available”, “Away”, “Unavailable”, “Offline”, “Busy” and “Invisible”, etc. In one embodiment of the present invention, the motion detection application determines whether the user is around, for example, whether the user is away or unavailable.

In an illustrative embodiment, the motion detection application is adapted to determine the user status to be “Online” or “Available” if the motion signals generated by the motion detector indicate the presence of motion, i.e., there is motion, most probably being a user's body movement, around the Internet telephony device. The motion detection application may also determine the user status to be “Away”, “Unavailable” or “Offline” if the motion signals indicate the absence of motion for a predetermined time period. For example, if the motion signals indicate that there is no motion detected for 20 minutes, it may be determined that the user is not around.

According to another embodiment of the present invention, the motion detection application may be adapted to determine the user status of the Internet telephony device based on proportion of a time period within which presence of motion is indicated by the motion signals.

If the motion signals detected by the motion detector within a first predetermined time period indicate presence of motion for less than a first specified proportion of said time period, the motion detection application may determine the user status to be “Away”. For example, the first predetermined time period is set to be 30 minutes and the motion signals are generated periodically, for example every 30 seconds. When the motion signals generated within this 30 minutes period indicate the presence of the user for less than 15 minutes, i.e. the first specified proportion is set to be 50% of the 30 minutes period, it may be determined that the user is “Away”. The first specified proportion may also set to be, e.g., 60% of the 30 minutes period. The user status of “Away” will provide the information to people in the contact list of the current user that the user may not be able to receive the call.

After the user status is determined to be “Away”, the motion detection application may further determine the user status based on the motion signals generated within a second predetermined time period. If the motion signals detected within the second predetermined time period indicate presence of motion for less than a second specified proportion of said time period, the motion detection application may determine the user status to be “Unavailable”. In one embodiment, the second predetermined time period is set to be 30 minutes. When the motion signals generated within this 30 minutes period indicate the presence of the user for less than 15 minutes, i.e. the second specified proportion is set to be 50% of the 30 minutes period, it may be determined that the user is “Unavailable”. Similarly, the second specified proportion may also be set to other values.

The motion detection application may suspend determining the user status if the current user status is set by the client application to be other than “Online” or “Available”. That means, only when the current user status is “Online” or “Available”, the motion detection application starts to determine whether the user is around, so as to provide such information to people in the contact list. If, for example, the user status is set to be “Busy”, it would indicate that the user do not want to be disturbed, no matter whether he is present or not. Therefore, the motion detection application does not need to determine the user status.

Furthermore, touching of a keypad of the Internet telephony device usually indicates the user is in the vicinity of the telephony device. The motion detection application may therefore determine the user status to be “Online” or “Available”. The telephony device may also include a locking unit, such that unauthorised touching of the keypad will not be considered for the determination of user status. Such a locking unit may be activated either by the press of a button on the panel of the telephony device, or by a plurality of PIN numbers inputted by the authorised user.

The motion detection application may communicate the determined user status to the client application. In an embodiment, the Internet telephony device is adapted to communicate the determined user status to the Internet telephony server. For example, this may be communicated by the client application embedded in the Internet telephony device. The communication of the determined user status from the Internet telephony device to the Internet telephony server may be actively initiated by the Internet telephony device. Alternatively, the communication may also be initiated upon a request from the Internet telephony server. Accordingly, the Internet telephony server will update the user status as displayed to people in the contact list upon receipt of the determined user status.

The Internet telephony device of the present application may further comprise other typical telephone components. Examples of these components include a display screen (for example, a LCD screen), keypad (including traditional keypad and electrically touch input keypad wherein numbers and letters can be integrated into a screen), voice coprocessor, acoustic echo canceller, speaker, microphones and network interface. The acoustic echo canceller, speaker and microphones may be included as part of the voice processing unit.

The present invention further relates to a method of monitoring user status of an Internet telephony device. The method comprises monitoring motion in the vicinity of the Internet telephony device by at least one motion detector and generating motion signals based on said monitoring of motion. The method further comprises determining the user status of the Internet telephony device based on the generated motion signals.

In an embodiment, the method further comprises communicating the determined user status to an Internet telephony server. This communication may be made through a client application embedded in the Internet telephony device. The method of the present invention may actively communicate the determined user status to the Internet telephony device, or start to communicate upon receiving a request from the Internet telephony device. Accordingly, the user status is updated on the Internet telephony server and will be displayed to people in the contact list.

In one embodiment, if the motion signals indicate presence of motion, it may determine the user status to be “Online” or “Available”. On the other hand, if the motion signals indicate absence of motion for a predetermined time period, it may determine the user status to be “Away”, “Unavailable” or “Offline”. For example, if the motion signals indicate absence of motion for 20 minutes, the user status may be determined to be “Away”; if the motion signals indicate absence of motion for 60 minutes, the user status may be determined to be “Unavailable”. Alternatively, the user status may be determined to be “Offline”, if the motion signals indicate absence of motion for a long period. The Internet telephony device may be disconnected or powered off if the user status is determined to be “Offline”.

According to another embodiment of the invention, the user status of the Internet telephony device is determined based on proportion of a time period within which presence of motion is indicated by the motion signals. This means that a short period of the presence (for example, 30 seconds or 2 minutes) may not be sufficient to obtain the status of availability. This also helps to improve the accuracy of the method, since the motion detected may be occasional movement of people or animals passing by.

If the motion signals generated within a first predetermined time period indicate presence of motion for more than a first specified proportion of said time period, the user status may be determined to be “Online” or “Available”. Whereas if the motion signals generated within the first predetermined time period indicate presence of motion for less than the first specified proportion of said time period, the user status may be determined to be “Away”.

After the user status has been determined to be “Away”, the user status may be determined to be “Unavailable” if the motion signals generated within a second predetermined time period indicate presence of motion for less than a second specified proportion of said time period. Whereas the user status may be maintained to be “Away” if the motion signals generated within the second predetermined time period indicate presence of motion for more than the second specified proportion of said time period.

In one embodiment, at each predetermined time point, there are more than one motion signals generated. For example, each motion detector may generate a motion signal if there is more than more motion detector positioned in the Internet telephony device. In such a case, if any one of the motion signals at the same time point indicates presence of motion, the motion is considered to be present at that time point. If none of the motion signals at the same time point indicates presence of motion, the motion is considered to be absent at that time point.

In a further embodiment, the determination of user status is suspended if a client application of the Internet telephony device set the current user status to be other than “Online” or “Available”. That means, the user may specifically set a user status, and may not wish the user status to be dynamically determined.

According to the invention, if a keypad of the Internet telephony device is touched, the user status may be determined to be “Online” or “Available”. This indicates that the user is most probably using or in the vicinity of the Internet telephony device. In another embodiment, the touching of the keypad may be ignored unless it is by an authorised user.

The Internet telephony device and the method of the present invention are further illustrated in the following with reference to the attached Figures.

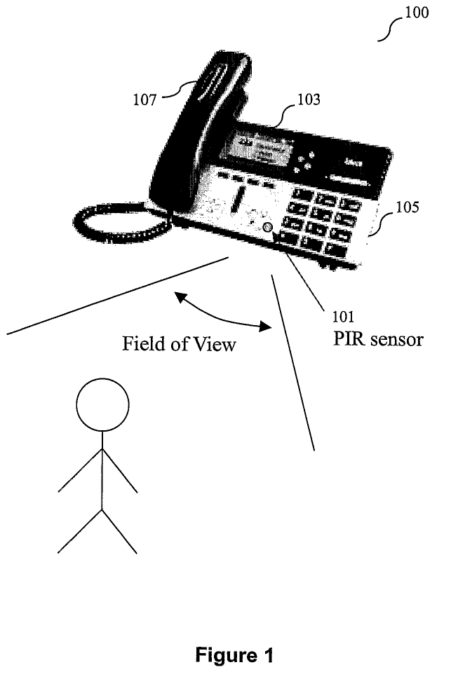

FIG. 1 shows an example of an Internet telephony device according to one embodiment of the invention. The device 100 comprises a PIR sensor 101 positioned in the front panel of the telephone device. The PIR sensor 101 is capable of detecting movement within its field of view. The device further comprises a LCD display 103, a keypad 105 and a handset 107, which are needed for making and receiving a call. Furthermore, the telephone device comprises a voice processing unit, a microprocessor embedded with a VoIP application, network interface, etc., which are inside the telephone device and not shown in the figure.

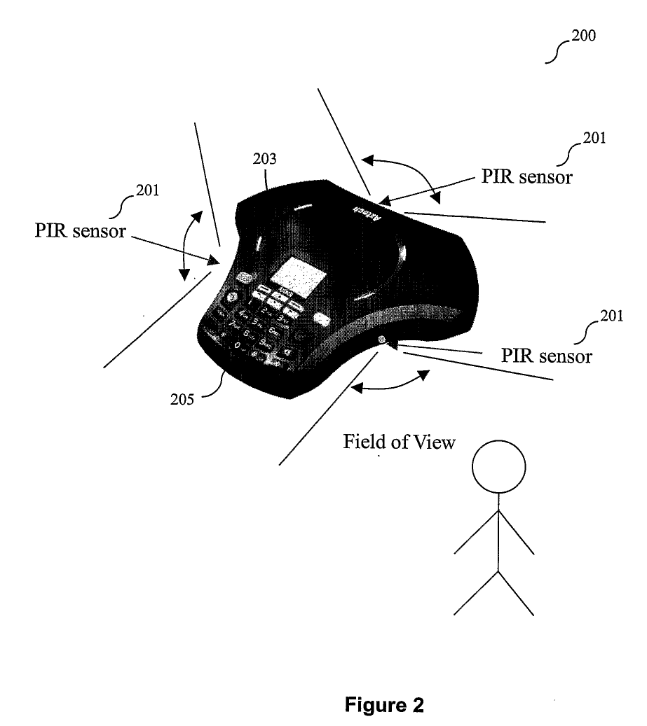

An example of the Internet telephony device according to another embodiment of the invention is shown in FIG. 2. Different from the Internet telephony device 100 of FIG. 1, the speakerphone device 200 does not include a handset. The speakerphone device 200 has embedded a VoIP application and is suitable for conference telephone conversation through Internet. In this illustrative example, the speakerphone device 200 comprises three PIR sensors 201 positioned in a circular manner in the device 200, thereby being capable of capturing body movement in almost 360 degree. Similar to the device 100 of FIG. 1, the speakerphone device 200 further comprises any one of LCD display 203, keypad 205, voice processing unit, microprocessor and network interface, etc.

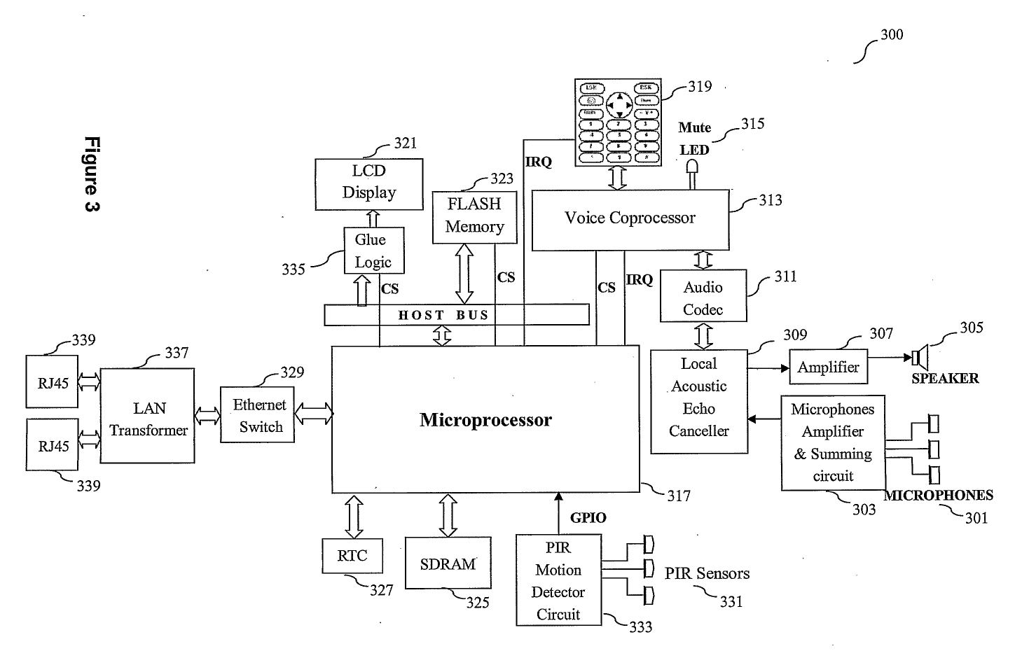

FIG. 3 shows an example of a hardware block diagram 300 of the Internet speakerphone device 200. There is a voice processing unit, which comprises several sub units, including microphones 301, a microphones amplifier and summing circuit 303, a speaker 305, an amplifier 307, an acoustic echo canceller 309, an audio codec 311, a voice coprocessor 313 and a mute LED 315. With these sub units, the voice processing unit is capable of converting voice signals into electrical signals and vice versa, performing a plurality of processing on the signals including amplifying, echo cancelling, encoding and decoding, etc.

For example, the voice signals are captured by the microphones 301, and then amplified and summed by the microphone amplifier and summing circuit 303. The amplified and summed voice signals are further processed through the local acoustic echo canceller 309 to remove the echo in the captured voice signals. Then the echo cancelled voice signals will be processed by the audio codec 311. The audio codec may be a hardware implementation or a sound card used for encoding an analog audio signal to a digital audio signal, or decoding an analog audio signal from a digital audio signal. In this sense, the audio codec may be considered as a combined audio AD/DA converter. Thus, the echo cancelled voice signals are converted to electrical signals, which will then be processed by the voice coprocessor 313 and transmitted to the Internet telephony server through the network. The voice coprocessor 313 is used to supplement the function of a microprocessor 317 of the phone device and helps to accelerate the system performance. The mute LED 315 is connected to the voice coprocessor 313 using any available GPIO (General Purpose Input/Output) pins, working as an indicator of whether the transmitting sound signal to the far end has been muted or not. Thus, though the voice processing unit, the speakerphone device 200 is able to convert the received voice signals into electrical signals and transmit the electrical signals over an IP-based network.

In another example, the local acoustic echo canceller 309 may integrate therein a line echo canceller which is used to remove the echo resulting from a PSTN (public switched telephone network) line. In other examples, the Internet speakerphone device 200 may further comprise a network echo canceller which can be used to remove any echo resulting from delays on a telecommunications circuit. When the electrical signals are received by the Internet speakerphone device 200 through the IP-based network, the network echo canceller can remove the echo which is caused by the delay due to the length of the circuit or due to packetization or queuing delay.

In the block diagram 300, there is also included a microprocessor 317, which processes the operating system software and the VoIP application software. As a central processing unit, the microprocessor 317 is typically connected with almost every peripheral component of the device, such as the voice coprocessor 313, keypad 319, LCD display 321, flash memory 323, SDRAM 325, real time clock (RTC) 327, Ethernet switch 329 and PIR motion detector. A glue logic 335 is also included, which acts as a custom electronic circuitry to achieve compatible interfaces between the LCD display 321 and the microprocessor 317. Some of the peripheral components, such as the glue logic 335, the flash memory 323 and the voice coprocessor 313 are connected to the microprocessor 317 through a host bus. In addition, the microprocessor 317 may communicate with the glue logic 335, the flash memory 323 and the voice coprocessor 313 via a CS (Chip Select) signal. If the microprocessor 317 tries to access a particular peripheral, it accesses read/write to a set of address with which the peripheral is associated. An address decode circuitry (which may be embedded in the microprocessor) will output a Chip Select signal to select the particular peripheral. During this time period, the address and data information on the host bus is only meant for the peripheral, other peripheral which is not chip selected will not react to the information on the host bus. On the other hand, the peripheral, such as the voice coprocessor 313 and the keypad 319 may communicate with the microprocessor 317 via an IRQ (Interrupt) signal. When a peripheral tries to send information to the microprocessor, it may output an IRQ signal to interrupt the microprocessor's routine. The microprocessor will then service the Interrupt and access the peripheral, depending on how the firmware is programmed. Furthermore, RJ45 (registered jack 45) 339 and a LAN transformer 337 are connected with the Ethernet switch 329 as interface to the computer network. The LAN transformer 337 used for Ethernet interfacing provides the electrical isolation for network safety. In addition to the RJ45 339 used for computer network, RJ11 connector may also be used when the Internet speakerphone device 200 is adapted to the public switched telephone network (PSTN).

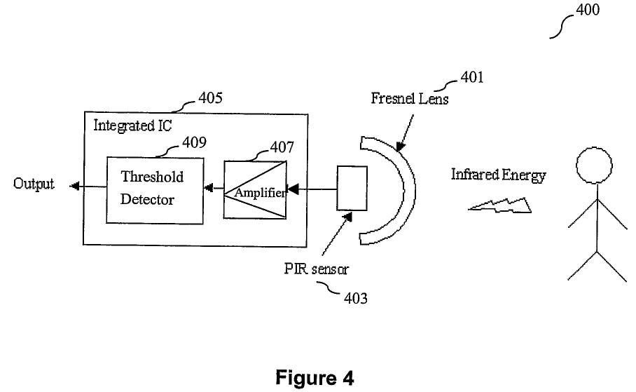

The PIR motion detector, which comprises PIR sensors 331 and a PIR motion detector circuit 333, is connected to the microprocessor 317 through GPIO (General Purpose Input/Output) or any other suitable interface. The structure of the PIR motion detector is illustrated in the block diagram 400 of FIG. 4. The PIR motion detector comprises a Fresnel lens 401 which is designed to focus the infrared energy emitted from an infrared emitting source, such as a human body, onto the PIR sensor 403. The PIR sensor 403 uses infrared light as a means of measuring temperature change, which is designed with precision and high sensitivity to pick up the infrared energy emitted from a human body. As a human body moves in front of the PIR sensor 403, the temperature change causes a ripple signal in the PIR sensor 403. This ripple signal is processed using a processing circuit 405. In particular, the ripple signal is amplified through an amplifier 407, and sent to a threshold detector 409 to determine whether the temperature change condition meets the preset parameter to identify the presence of human. Depending on the design of the Fresnel lens 401, the field of view may be varied. Furthermore, the range of detection depends on the PIR sensor 403, the Fresnel lens 401 and the sensitivity of the processing circuit 405. In general, a range of up to 3 or 4 meters will be sufficient, but a broader range may also be achieved depending on the design of the motion detector.

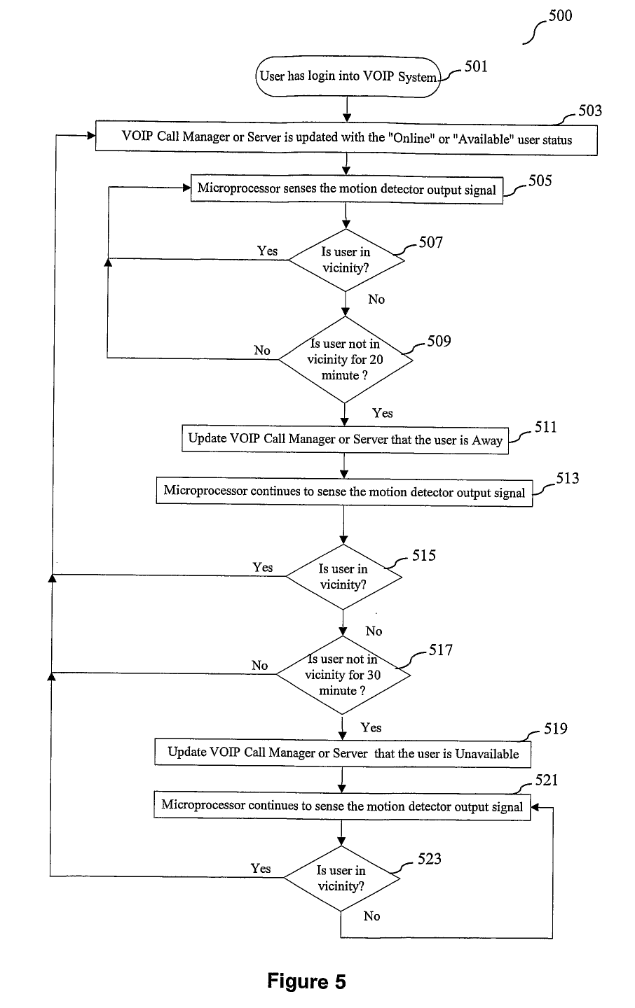

FIG. 5 shows an example of a flow chart of the operation of user detection and updating of the “Online” status to the VoIP Call Manager or Server according to one embodiment of the invention. It starts with the user logging into the VoIP system at 501. The VoIP Call Manager or Server is updated with the user status as currently be “Online” or “Available” at 503. When the PIR motion detector detects human movement, it will signal a “True” state to the microprocessor at 505. This can be achieved through a level signal change where the microprocessor will poll for the signal change, or through hardware interrupts where the Microprocessor is notified of the signal change. The microprocessor under the control of the VoIP application software will then determine the user status using motion detection application software based on the current state of the usage. For example, as shown in the flow chart, the microprocessor monitors whether the user is in the vicinity at 507. If there is an extended period of no human movement 509, for example for 20 minutes, the VoIP application software will change the user status to “Away” and update the VoIP Call Manager or Server accordingly at 511. The microprocessor continues monitoring the signals output from the motion detector at 513. When the user returns into the vicinity of the Internet telephony device at 515, the microprocessor will sense this new status from the PIR motion detector and put the user status back to “Online” or “Available”. The VoIP Call Manager or Server will be updated accordingly at 503. However, if there is a period of no human movement for another 30 minutes at 517, the microprocessor will change the user status to be “Unavailable”, and update the VoIP Call Manager of the status change at 519. The microprocessor continues to sense the PIR motion detector at 521 to determine whether the user is in the vicinity at 523, until the user returns and be detected in the vicinity. This process will continue till the user logged out from the VoIP system. However, in any case the user has the liberty to override the “Online” status, through manual setting by keypad entry.

Thus, without the means of mouse and keyboard activity to detect user status, the Internet telephony device using PIR motion detector can effectively provide a good estimate of the user status in respect to the use of the telephone device. The user status can accordingly be updated to the VoIP call manager or server.

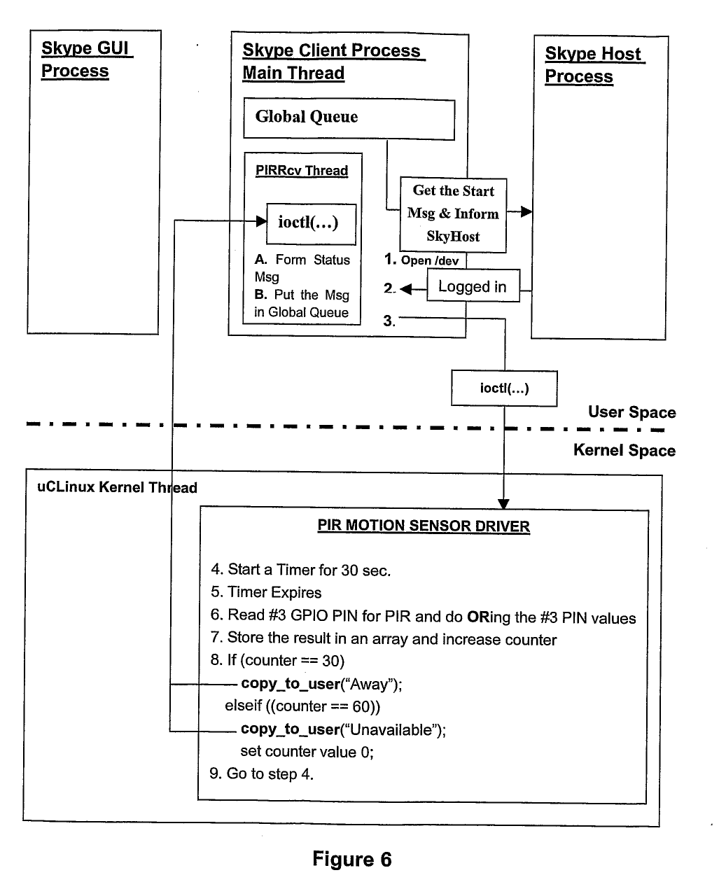

FIG. 6 shows an example of one embodiment of the present invention with regard to the software communication mechanism and algorithm among the Skype™ server application, the Skype™ client application and the motion detection application. The communication process is explained below.

STEP 1. Open the Internet telephony device associated with PIR motion detector (/dev/pir) in Skype™ Client's main thread for communication to PIR Motion Sensor Driver at kernel space.

STEP 2. Log in with the Skype™ Host process.

STEP 3. At the main thread of Skype™ Client process, upon successful login with Skype™ network, call ioctl( . . . ) on PIR device with PIR_LOGIN_EVT command to inform the driver about the first login, thereby the driver starts time counting to detect “Away” or “Unavailable” conditions.

STEP 4. PIR Driver starts a timer for a duration of 30 seconds.

STEP 5. Wait for the time to expire.

STEP 6. As soon as the time expires, the three PIR Sensor attached GPIO (General Purpose Input/Output) PINs are read. An OR operation is further performed for these three values together.

STEP 7. The result of the OR operation is stored in an array.

STEP 8. Keep an elapsedTimeCounter to get the elapsed time. Repeat STEP 4-STEP 7 and increment the elapsedTimeCounter until it reaches the value of 30. When the elapsedTimeCounter is 30, the elapsed time is accumulated for 15 minutes. If it is determined from the values stored in the array that the user is not in the vicinity for 15 minutes, inform the Skype™ Client application's PIRRcvThread that the user status is “Away”. Increment the elapsedTimeCounter until it reaches the value of 60, then the elapsed time is accumulated for 30 minutes. If it is determined from the values stored in the array that the user is not in the vicinity for 30 minutes, inform the Skype™ Client application's PIRRcvThread that the user status is “Unavailable”, and reset the elapsedTimeCounter to zero.

STEP 9. Go back to STEP 4.

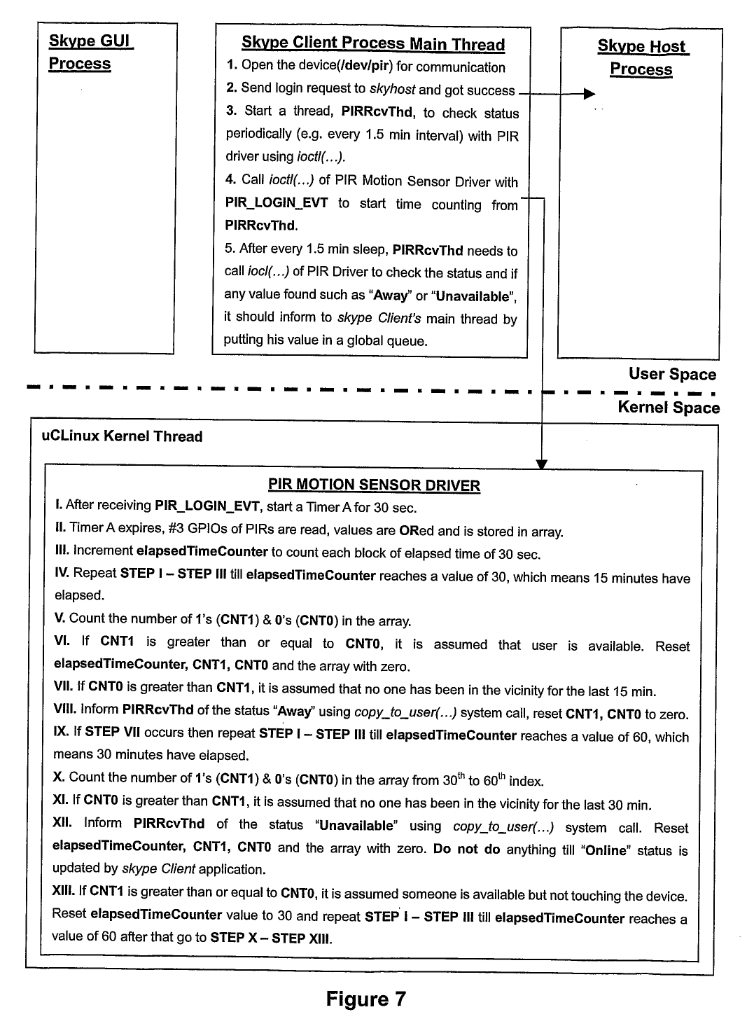

According to another embodiment of the present invention as illustrated in FIG. 7, the software communication mechanism and algorithm among the Skype™ server application, the Skype™ client application and the motion detection application can be as follows.

STEP 1. Open the Internet telephony device associated with PIR motion detector (/dev/pir) in Skype™ Client's main thread for communication to PIR Motion Sensor Driver at kernel space.

STEP 2. At the main thread of Skype™ Client process, send login request to Skype™ Host process and log in accordingly.

STEP 3. Upon successful login with Skype™ network, start a thread PIRRcvThd to check user status periodically, e.g., every 1.5 minutes interval.

STEP 4. Call ioctl( . . . ) of PIR motion sensor driver with PIR_LOGIN_EVT command to inform the driver about the first login, thereby the driver starts time counting to detect “Away” or “Unavailable” conditions.

The detection of the user status by the PIR motion sensor driver is elaborated in the following.
I. After receiving the PIR_LOGIN_EVT command, start a Timer A for 30 seconds.
II. Upon expiry of the Timer A, read the three PIR sensor attached GPIO (General Purpose Input/Output) pins. Perform an OR operation for the three values and store the result in an array.
III. Increment a counter elapsedTimeCounter to count each time block of 30 seconds.
IV. Repeat I-III until elapsedTimeCounter reaches a value of 30, which means 15 minutes have elapsed.
V. Determine the number of 1's (CNT1) and the number of 0's (CNT0) in the array.
VI. If CNT1 is greater than or equal to CNT0, it is assumed that the user is in the vicinity, and the user status is determined to be “Online”. Reset elapsedTimeCounter, CNT1, CNT0 and the array to be zero, and return to step I.
VII. If CNT0 is greater than CNT1, it is assumed that the user has not been in the vicinity in the last 15 minutes, and the user status is determined to be “Away”.
VIII. Inform PIRRcvThd of the user status “Away” using the system call copy_to_user( . . . ). Reset CNT0 and CNT1 to zero.
IX. If step VII occurs, repeat step I-III until elapsedTimeCounter reaches a value of 60, which means 30 minutes have elapsed.
X. Determine the number of 1's (CNT1) and the number of 0's (CNT0) in the array from the 30th to 60th index.
XI. If CNT0 is greater than CNT1, it is assumed that the user has not been in the vicinity in the last 30 minutes, and the user status is determined to be “Unavailable”.
XII. Inform PIRRcvThd of the user status “Unavailable” using the system call copy_to_user( . . . ). Reset elapsedTimeCounter, CNT1, CNT0 and the array to be zero. Stop the detection process by the PIR motion sensor driver until the Skype™ Client application updates the PIR motion sensor driver with the “Online” status.
XIII. If CNT1 is greater than or equal to CNT0, it is assumed that someone is in the vicinity but not touching the telephone device, e.g., the keypad. Reset elapsedTimeCounter to the value of 30, and repeat step I-III until elapsedTimeCounter reaches the value of 60. Then, go to step X-XIII.

STEP 5. After every 1.5 minutes, the PIRRcvThd will call ioctl( . . . ) of PIR motion sensor driver to check the user status. If the user status is determined to be “Away” or “Unavailable”, this status value will be informed to the Skype™ Client's main threat, and will be put in a global queue to update the Skype™ Host process.

It is noticed that the step VI above can be considered as a Reset step. If the Skype™ Client Process calls ioctl( . . . ) to inform the PIR Driver of the “Online” status, all counters and arrays need to be reset with value zero and the process of detecting the user status will restart from the beginning.

The above algorithm may further comprise a Stop step. For example, if the Skype™ Client Process calls ioctl( . . . ) to inform the PIR driver of some status, such as “Busy”, and “Invisible”, all counters and arrays need to be reset with value zero and the detection process by the PIR driver stops until the Skype™ Client application informs PIR Driver of the “Online” status. This is in the case that the user deliberately sets some user status to avoid the automatic determination and update of user status.

In the above illustrated embodiment, the PIR motion detection application determines the user status to be “Away” if less than half of the motion signals generated in the first 15 minutes indicate presence of body movement. In the next 15 minutes, if less than half of the motion signals indicate presence of body movement, the user status will be determined to be “Unavailable”. Whereas, if more than half of the motion signals indicate presence of body movement, the user status will be maintained as “Away”, and the motion signals generated in the third 15 minutes period will be processed. Thus, according to this embodiment, though PIR motion detector detect body movement in the vicinity, it may not be sufficient to be considered for status change. Only if the keypad of the telephone device is touched, the user status may be determined to be “Online”, as in Step XII above.

By the foregoing device and method, the user status of an Internet telephony device is monitored and updated based on motion detected by motion detectors. Therefore, the lack of mouse or keyboard would not be a problem for standalone Internet telephony device. Furthermore, the present invention also provides a more accurate determination of user status, such that occasional motion or motion within a short period will not be considered for status change.

Although the present invention has been disclosed and illustrated with respect to preferred embodiments thereof, it should be understood that the above illustrated embodiments should not be taken as limiting the scope of the invention and that various changes and modifications can be made within the full intended scope of the invention as hereinafter claimed.

1-27. (canceled)

28. An Internet telephony device, comprising:
a voice processing unit capable of processing voice signals into electrical signals and vice versa;
a microprocessor comprising an embedded client application capable of communicating said electrical signals to an Internet telephony server over a network; and
at least one motion detector adapted to generate motion signals based on monitoring of motion in the vicinity of the Internet telephony device;
wherein the at least one motion detector comprises at least one infrared sensor capable of detecting motion of an infrared emitting source;
wherein the at least one motion detector is integrated in the device;
wherein the at least one motion detector is coupled to the microprocessor to determine a user availability status of said Internet telephony device based on a proportion of a time period within which presence of motion is indicated by the motion signals.

29. The Internet telephony device of claim 28, wherein the client application is a Voice over Internet Protocol (VoIP) application.

30. The Internet telephony device of claim 28, wherein the at least one motion detector comprises at least one sensor selected from passive infrared sensor (PIR), ultrasonic sensor or microwave sensor.

31. The Internet telephony device of claim 28, wherein the infrared sensor is a Passive Infrared Sensor (PIR).

32. The Internet telephony device of claim 28, further comprising a motion detection application.

33. The Internet telephony device of claim 32, wherein the motion detection application is embedded in the microprocessor.

34. The Internet telephony device of claim 32, wherein the motion detection application is embedded in the at least one motion detector.

35. The Internet telephony device of claim 32, wherein the motion detection application is adapted to determine the user availability status to be “Online” or “Available” if the motion signals indicate the presence of motion, within a specific range and to determine the user status to be “Away”, “Unavailable” or “Offline” if the motion signals indicate the absence of motion within a specific range for a predetermined time period.

36. The Internet telephony device of claim 35, wherein the motion detection application is adapted to determine the user status to be “Away”, if the motion signals generated within a first predetermined time period indicate presence of motion for less than a first specified proportion of said time period.

37. The Internet telephony device of claim 36, wherein the motion detection application is adapted to determine the user status to be “Unavailable” if after the user status is determined to be “Away”, the motion signals generated within a second predetermined time period indicate presence of motion for less than a second specified proportion of said time period.

38. The Internet telephony device of claim 32, wherein the motion detection application is adapted to suspend determining the user status if the current user status is set by the client application to be other than “Online” or “Available”.

39. The Internet telephony device of claim 32, wherein the motion detection application is adapted to determine the user status to be “Online” or “Available” if keypad of the Internet telephony device is touched.

40. The Internet telephony device of claim 32, wherein the motion detection application is adapted to communicate the determined user status to the client application.

41. The Internet telephony device of claim 32, wherein the Internet telephony device is adapted to communicate the determined user status to the Internet telephony server, thereby updating the Internet telephony server.

42. The Internet telephony device of claim 28, further comprising at least one of a display screen, keypad, voice coprocessor, acoustic echo canceller, speaker, microphones and network interface.

43. A method of monitoring a user status of an Internet telephony device, comprising:
monitoring motion in the vicinity of the Internet telephony device by at least one motion detector, wherein the at least one motion detector comprises at least one infrared sensor, capable of detecting motion of an infrared emitting source, and is integrated into the said Internet telephony device;
detecting and generating motion signals based on said monitoring of motion; and
determining the user status of the Internet telephony device based on proportion of time period within which presence of motion is indicated.

44. The method of claim 43, wherein the infrared sensor is a Passive Infrared Sensor (PIR).

45. The method of claim 43, further comprising communicating the determined user status to an Internet telephony server, thereby updating the user status on the Internet telephony server.

46. The method of claim 43, further comprising determining the user status to be “Online” or “Available” if the motion signals indicate presence of motion.

47. The method of claim 43, further comprising determining the user status to be “Away”, “Unavailable” or “Offline” if the motion signals indicate absence of motion for a predetermined time period.
